(19) United States
(12) Patent Application Publication
(10) Pub. No.: US 2006/0215915 A1
(43) Pub. Date: Sep. 28, 2006

(54) Device and method for generating thumbnail JPEG image and medium for storing thumbnail JPEG image

(75) Inventor: Myoung Gyun Kim, Seoul (KR)

Correspondence Address: FOLEY AND LARDNER LLP;SUITE 500, 3000 K STREET NW, WASHINGTON, DC, 20007, US

(73) Assignee: Core Logic Inc.

(21) Appl. No.: 11/271,827

(22) Filed: Nov. 14, 2005

(30) Foreign Application Priority Data
Mar. 23, 2005 (KR) 10-2005-0024206

(51) Int. Cl. G06K 9/36; G06K 9/32

(52) U.S. Cl. 382/232; 382/298

(57) ABSTRACT

Disclosed herein is a device and method for generating a thumbnail Joint Picture Experts group (JPEG) image and a medium for storing the thumbnail JPEG. The device includes a scaler, first frame memory, a JPEG signal processing unit, second frame memory and a memory control unit. The scaler scales an input image to a predetermined size to output an image for main JPEG, and scales the input image to a size smaller than the image for main JPEG and to outputs a thumbnail JPEG image. The first frame memory stores the thumbnail JPEG image. The JPEG signal processing unit performs JPEG encoding on the image for main JPEG and the thumbnail JPEG image, and outputs a main JPEG image and a thumbnail JPEG image. The second frame memory stores the main JPEG image and the thumbnail JPEG image. The memory control unit transfers the thumbnail JPEG image to the first frame memory, and transfers the main JPEG image and the thumbnail JPEG image to the second frame memory. Additionally, the JPEG signal processing unit receives the main JPEG image and the thumbnail JPEG image stored in the second frame memory, and outputs the main JPEG image and the thumbnail JPEG image as a single JPEG file.

This Nonprovisional application claims priority under 35 U.S.C. § 119(a) on Patent Application No. 2005-0024206 filed in Korea on Mar. 23, 2005 the entire contents of which are hereby incorporated by reference.

### BACKGROUND OF THE INVENTION

1. Field of the Invention

The present invention relates generally to a device and method for generating a thumbnail Joint Picture Experts group image, and a medium for storing the thumbnail Joint Picture Experts group image and, more particularly, to a device and method for generating a thumbnail Joint Picture Experts group image, which is capable of effectively outputting and displaying a Joint Picture Experts group image in a digital still camera, and a medium for storing the thumbnail Joint Picture Experts group image.

2. Description of the Related Art

Generally, a digital still camera converts input analog image signals into digital signals, processes the digital signals, stores digital image data, which are generated as the result of signal processing, in frame memory, compresses the stored digital image data, and then stores the compressed digital image data on a storage medium, such as a memory card or a flash card.

Images stored on the storage medium, such as a memory card or a flash card, may be printed and output in picture form using a computer. Furthermore, in the digital still camera, the images, which are photographed by a user, are stored on a storage medium, such as a memory card or a flash card, so that they are capable of being reproduced and viewed through the screen of a display device, such as a Liquid Crystal Display (LCD), without being printed in picture form. Accordingly, images that are poorly photographed or dissatisfactory can be removed from the storage medium, such as a memory card or a flash card, and edited using a digital still camera or a computer.

Meanwhile, thumbnail images are provided to easily search for images that have been stored in the storage medium of the digital still camera. Such thumbnail images are utilized in such a way that the images stored in the storage medium are scaled down and then displayed on an LCD in the form of a plurality of screens, and only a desired, selected screen is magnified to the size of its original image and then displayed on the LCD when a user searches the plurality of screens for the desired screen and selects the desired image. Accordingly, since a plurality of images photographed can be scaled down and displayed on the LCD, an image desired by the user can easily be searched for.

However, the conventional digital still camera is inconvenient in that it generates a thumbnail image, which is scaled down compared to an original image, by sub-sampling the original image whenever the thumbnail image is needed.

### SUMMARY OF THE INVENTION

Accordingly, the present invention has been made keeping in mind the above problems occurring in the prior art, and an object of the present invention is to provide a device for generating a thumbnail Joint Picture Experts Groups (JPEG) image that can effectively output and display a JPEG image.

Another object of the present invention is to provide a method of generating the thumbnail JPEG image.

A further object of the present invention is to provide a medium for storing the thumbnail JPEG image.

Objects to be accomplished by the present invention are not limited to the objects described above, and other objects not described above will be clearly understood by those skilled in the art from the following descriptions.

In order to accomplish the first object, the present invention provides a device for generating an image for thumbnail JPEG, including a scaler for scaling an input image to a predetermined size and outputting an image for main JPEG, and scaling the input image to a size smaller than the image for main JPEG and outputting an image for thumbnail JPEG; first frame memory for storing the image for thumbnail JPEG; a JPEG signal processing unit for performing JPEG encoding on the image for main JPEG and the image for thumbnail JPEG, and outputting a main JPEG image and a thumbnail JPEG image; second frame memory for storing the main JPEG image and the thumbnail JPEG image; and a memory control unit for transferring the image for thumbnail JPEG to the first frame memory, and transferring the main JPEG image and the thumbnail JPEG image to the second frame memory; wherein the JPEG signal processing unit receives the main JPEG image and the thumbnail JPEG image stored in the second frame memory, and outputs the main JPEG image and the thumbnail JPEG image as a single JPEG file.

In accordance with the present invention, the JPEG signal processing unit inserts the thumbnail JPEG image into the header area of the main JPEG image, and outputs the main JPEG image and the thumbnail JPEG image as a single JPEG file.

In accordance with the present invention, the JPEG signal processing unit includes a scanning unit for scanning the image for main JPEG and the image for thumbnail JPEG on a predetermined size block basis; a Discrete Cosine Transform (DCT) signal processing unit for performing DCT signal processing on the scanned data; a quantization unit for quantizing the DCT signal processed data; a Huffman coding unit for performing Huffman coding on the quantized data; and a file combining unit for outputting the main JPEG image and the thumbnail JPEG image based on the Huffman coded data, inserting the thumbnail JPEG image into the header area of the main JPEG image, and outputting the main JPEG image and the thumbnail JPEG image as a single JPEG file.

In accordance with the present invention, the device further includes a memory card for storing the output single JPEG file.

In order to accomplish the second object, the present invention provides a method of generating an image for thumbnail JPEG, including the steps of scaling an input image to a predetermined size and outputting an image for main JPEG, and scaling the input image to a size smaller than the image for main JPEG and outputting an image for thumbnail JPEG; transferring the image for thumbnail JPEG to first frame memory, and storing the image for thumbnail JPEG in the first frame memory; performing JPEG encoding on the image for main JPEG, and outputting a main JPEG image; transferring the main JPEG image to second frame memory, and storing the main JPEG image in the second frame memory; receiving the image for thumbnail JPEG stored in the first frame memory, performing JPEG encoding on the image for thumbnail JPEG, and outputting a thumbnail JPEG image; transferring the thumbnail JPEG image to the second frame memory, and storing the thumbnail JPEG image in the second frame memory; and receiving the main JPEG image and the thumbnail JPEG image stored in the second frame memory, and outputting the main JPEG image and the thumbnail JPEG image as a single JPEG file.

In accordance with the present invention, the thumbnail JPEG image is inserted into the header area of the main JPEG image, and the main JPEG image and the thumbnail JPEG image is output as a single JPEG file, at the step of outputting the main JPEG image and the thumbnail JPEG image as a single JPEG file.

In accordance with the present invention, the step of outputting the main JPEG image includes the steps of: scanning the image for main JPEG on a predetermined size block basis; performing DCT signal processing on the scanned data; quantizing the DCT signal processed data; and performing Huffman coding on the quantized data.

In accordance with the present invention, the step of outputting the thumbnail JPEG image includes the steps of: scanning the image for thumbnail JPEG on a predetermined size block basis; performing DCT signal processing on the scanned data; quantizing the DCT signal processed data; and performing Huffman coding on the quantized data.

In accordance with the present invention, the method further includes the step of storing the output single JPEG file on a memory card after the step of outputting the main JPEG image and the thumbnail JPEG image as a single JPEG file.

In order to accomplish the third object, the present invention provides a medium for storing an image for thumbnail JPEG, the medium storing a main JPEG image and a thumbnail JPEG image as a single JPEG file.

In accordance with the present invention, the thumbnail JPEG image is inserted into the header area of the main JPEG image, and the main JPEG image and the thumb JPEG image are stored therein as a single JPEG file.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a digital still camera to which an embodiment of the present invention is applied;

FIG. 2 is a block diagram showing the construction of a device for generating a thumbnail JPEG image according to the present invention;

FIG. 3 is a block diagram showing the construction of the JPEG signal processing unit of FIG. 2 in detail;

FIG. 4 is a view showing the structure of the data packet of a JPEG file that is stored in a medium for storing a thumbnail JPEG image according to an embodiment of the present invention;

FIG. 5 is a flowchart illustrating a method of generating a thumbnail JPEG image according to an embodiment of the present invention;

FIG. 6 is a detailed flowchart illustrating the step of outputting the main JPEG image of FIG. 5; and

FIG. 7 is a detailed flowchart illustrating the step of outputting the thumbnail JPEG image of FIG. 5.

### DESCRIPTION OF THE PREFERRED EMBODIMENTS

The advantages and characteristics of the present invention, and a method of achieving them will be apparent with reference to embodiments described in detail later in conjunction with the accompanying drawings. The same reference numerals are used throughout the different drawings to designate the same or similar components.

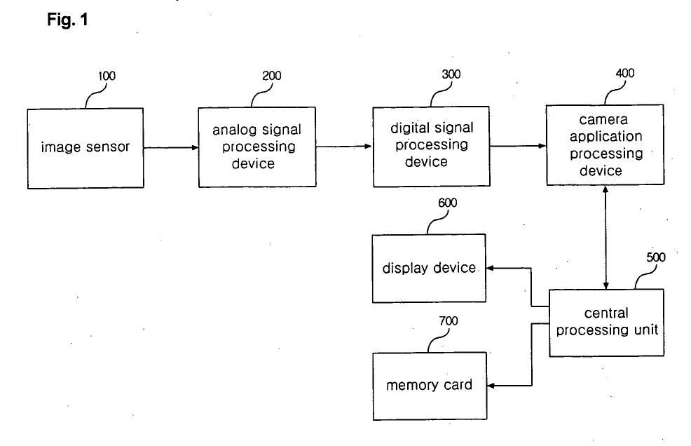

With reference to FIG. 1, a digital still camera to which an embodiment of the present invention is applied is described. FIG. 1 is a block diagram showing the construction of the digital still camera to which the embodiment of the present invention is applied.

The digital still camera to which the embodiment of the present invention is applied includes an image sensor 100, an analog signal processing device 200, a digital signal processing device 300, a camera application processing device 400, a central processing unit 500, a display device 600 and a memory card 700.

The image sensor 100 is a device for photographing images using the light-sensitive characteristic of a semiconductor, which detects the varying brightness and wavelength of light reflected from subjects, and converts the detected brightness and wavelength into electrical values using pixels. The conversion of the electrical values into a level at which signal processing can be performed is the function of the image sensor 100.

That is, the image sensor 100 is a semiconductor device for converting optical images into electrical signals. Of such image sensors, a Charge Coupled Device (CCD) image sensor is a device in which individual Metal Oxide Semiconductor (MOS) capacitors are located closely adjacent to each other, and charges are stored in the capacitors and transferred, and a Complementary Metal Oxide Semiconductor (CMOS) image sensor 100 is a device that uses the CMOS technique of using a control circuit and a signal processing circuit as peripheral circuits and adopts the switching method of sequentially detecting output by forming and using MOS transistors in proportion to the number of pixels.

Such a CMOS image sensor has the great advantage of low power consumption, so that it is very useful for a personal portable device, such as a mobile phone. Accordingly, the CMOS image sensor can be used in various applications, such as Personal Computer (PC) cameras, medical applications and toy cameras.

In detail, the image sensor 100 includes an optical imaging system, including a lens, an iris and an electronic shutter, and a CMOS imaging device. In the image sensor 100, when light is incident on the CMOS imaging device from a subject through the optical imaging system, photoelectrical conversion is performed by the CMOS imaging device, so that analog image signals are acquired from the CMOS imaging device.

Meanwhile, the CMOS imaging device is formed in such a way that, on a CMOS substrate, a plurality of pixels, each of which includes a photodiode, a transfer gate, a switching transistor, an amplification transistor and a reset transistor, are arranged in two-dimensional form, and a vertical scanning circuit, a horizontal scanning circuit and an image signal output circuit are formed. Such a CMOS imaging device can acquire Red, Green and Blue (RGB) analog image signals or complementary color analog image signals.

The analog image signals from the CMOS imaging device are sampled and held on a color basis, the gains of the analog signals are controlled by auto gain control, and then the analog image signals are converted into digital image signals in the analog signal processing device 200.

The digital image signals from the analog signal processing device 200 are converted into a luminance signal Y, a red chrominance signal Cr and a blue chrominance signal Cb in the digital signal processing device 300, and are then output to the display device 600, such as an LCD.

The digital image signals, which are converted into the luminance signal Y, the red chrominance signal Cr and the blue chrominance signal Cb by the digital signal processing device 300, are scaled to the screen size of the display device 600, such as an LCD, or are output as a main JPEG image and a thumbnail JPEG image.

Under the control of the central processing unit 500, the image scaled to the screen size of the display device 600, such as an LCD, is transferred to the display device 600, such as an LCD, and is displayed on the display device 600, such as an LCD. Under the control of the central processing unit 500, the main JPEG image and the thumbnail JPEG image are transferred to the memory card 700 and are stored on the memory card 700.

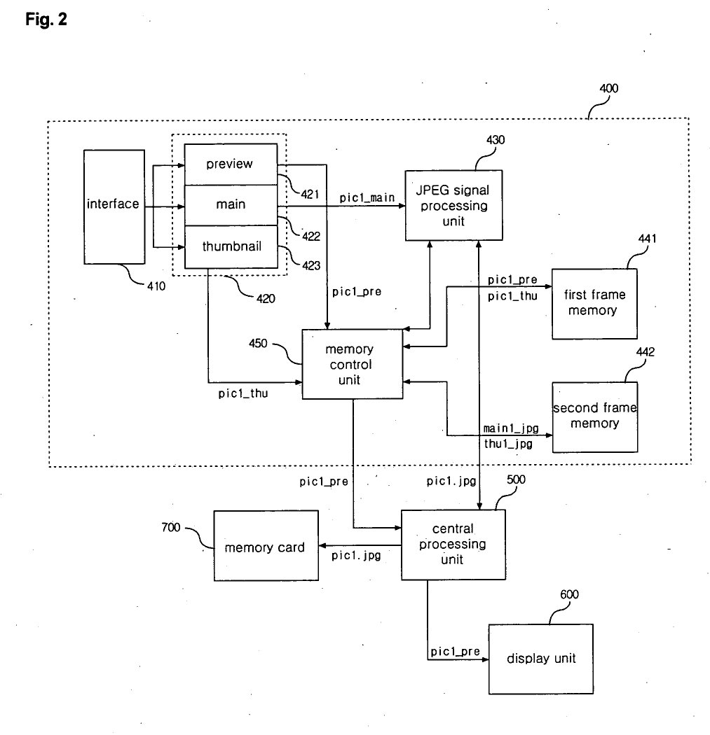

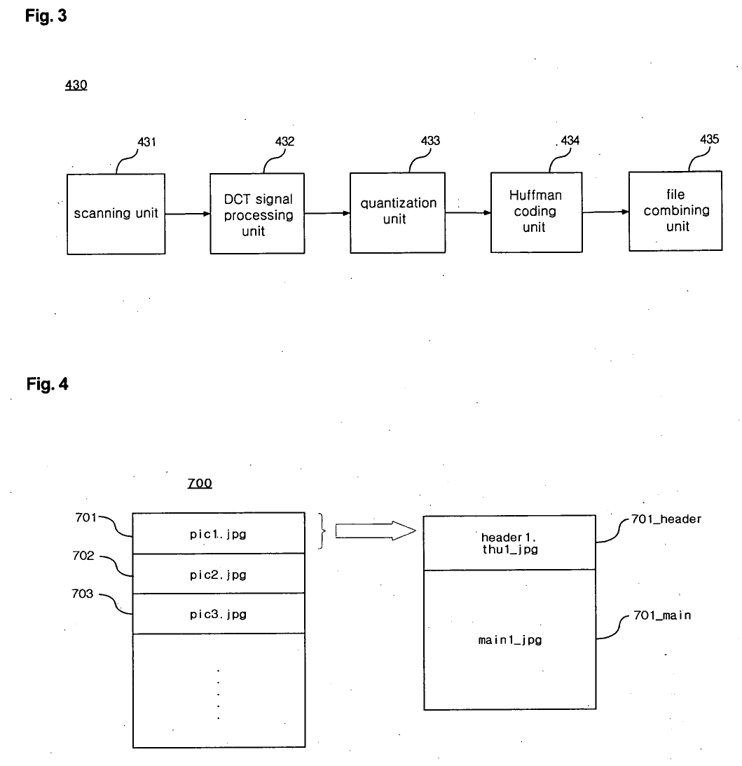

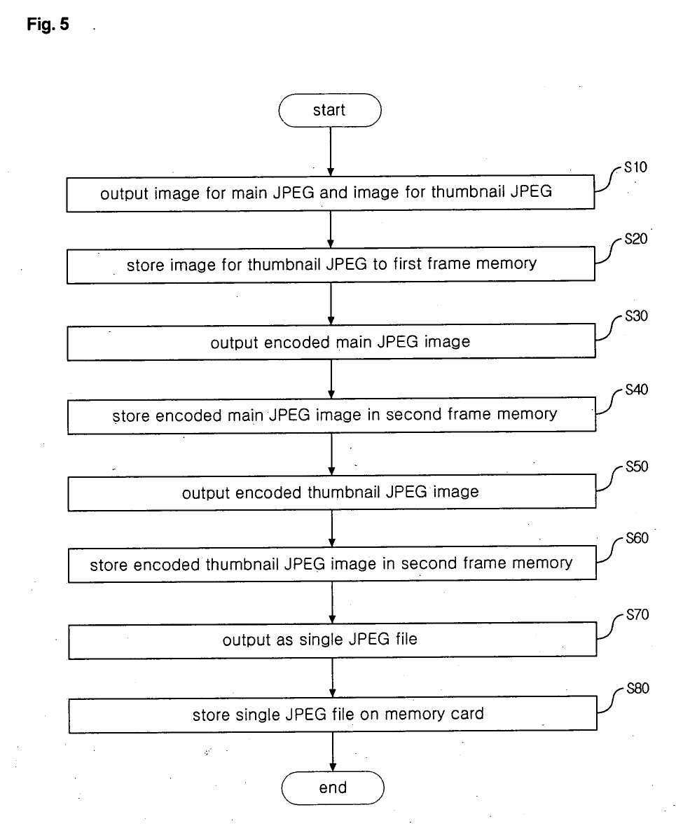

With reference to FIGS. 2 to 4, the device for generating a thumbnail JPEG image according to the embodiment of the present invention is described. FIG. 2 is a block diagram showing the construction of the device for generating a thumbnail JPEG image according to the present invention, FIG. 3 is a block diagram showing the construction of the JPEG signal processing unit of FIG. 2 in detail, and FIG. 4 is a view showing the structure of the data packet of a JPEG file that is stored in a medium for storing a thumbnail JPEG image according to the embodiment of the present invention.

The device for generating thumbnail JPEG images according the embodiment of the present invention includes a scaler 420, first frame memory 441, a JPEG signal processing unit 430, second frame memory 442 and a memory control unit 450.

The image, which is converted into the luminance signal Y, the red chrominance signal Cr and the blue chrominance signal Cb by the digital signal processing device, is input to the scaler 420 through an interface 410.

The scaler 420 includes a preview scaler 421, a main scaler 422 and a thumbnail scaler 423. The preview scaler 421 scales the image input through the interface 410 and outputs a display image pic1_Pre, the main scaler 422 scales the image input through the interface 410 and outputs an image for main JPEG pic1_main, and the thumbnail scaler 423 scales the image input through the interface 410 to a size smaller than that of the image for main JPEG pic1_main, and outputs an image for thumbnail JPEG pic1_thu.

In this case, the preview scaler 421, the main scaler 422 and the thumbnail scaler 423 horizontally and vertically interpolates the input image, so that scaling can be performed simultaneously. Meanwhile, the size of the image for main JPEG pic1_main may be variously set. For example, the size may be set to 640*480 in the case of Video Graphics Array (VGA) resolution, and may be set to 102.4*768 in the case of Extended Graphics Array (XGA) resolution. Furthermore, the size of the image for thumbnail JPEG pic1_thu may be variously set to a ratio of one to two, one to four, one to eight or one to sixteen, compared to the size of the image for main JPEG pic1_main.

The preview scaler 421 outputs the display image pic1_pre and transfers it to the control unit 450. The thumbnail scaler 423 outputs and transfers the image for thumbnail JPEG pic1_thu to the memory controller 450. The memory control unit 450 transfers the display image pic1_pre and the image for thumbnail JPEG pic1_thu to the first frame memory 441 and, thereafter, the display image pic1_pre and the image for thumbnail JPEG pic1_thu are stored in the first frame memory 441. Furthermore, the display image pic1_pre stored in the first memory 441 is transferred to the central processing unit 500 under the control of the memory control unit 450. The central processing unit 500 transfers the display image pic1_pre to the display device 600, such as an LCD, and causes the display image pic1_pre to be displayed on the display device 600, such as an LCD.

The main scaler 422 outputs the image for main JPEG pic1_main and transfers it to the signal processing unit 430. The JPEG signal processing unit 430 performs JPEG encoding on the image for main JPEG pic1_main, and outputs a main JPEG image main1_jpg. Furthermore, the output main JPEG image main1_jpg is transferred to the memory control unit 450. The memory control unit 450 transfers the main JPEG image main1_jpg to the second frame memory 422, and the main JPEG image main1_jpg is stored in the second frame memory 442. In this case, each of the first and second frame memories 441 and 442 may be implemented using Dynamic Random Access Memory (DRAM), Static Random Access Memory (SRAM), or flash memory. Furthermore, the first and second frame memories 441 and 442 do not need to be separately implemented using DRAM, SRAM or flash memory, but they may be implemented by bi-sectioning the area of any one of DRAM, SRAM and flash memory.

The image for thumbnail JPEG pic1_thu, which has been stored in the first frame memory 441, is transferred to the JPEG signal processing unit 430 under the control of the memory control unit 450. The JPEG signal processing unit 430 performs JPEG encoding on the image for thumbnail JPEG pic1_thu, and outputs the thumbnail JPEG image thu1_jpg. The output thumbnail JPEG image thu1_jpg is transferred to the memory control unit 450, the memory control unit 450 transfers the thumbnail JPEG image thu1_jpg to the second frame memory 442, and the thumbnail JPEG image thu1_jpg is stored in the second frame memory 442.

The JPEG signal processing unit 430 receives the main JPEG image main1_jpg and the thumbnail JPEG image thu1_jpg under the control of the memory control unit 450, inserts the thumbnail JPEG image thu1_jpg into the header area of the main JPEG image main1_jpg, and outputs the main JPEG image main1_jpg and the thumbnail JPEG image thu1_jpg as a single JPEG file pic1.jpg. In this case, the header area of the main JPEG image main1_jpg includes data on the size of an main JPEG main1_jpg, and Discrete Cosine Transform (DCT) signal processing, quantization and Huffman coding methods that are used in JPEG encoding.

Accordingly, the thumbnail JPEG image thu1_jpg is inserted into the header area of the main JPEG main1_jpg, and the main JPEG main1_jpg and the thumbnail JPEG image thu1_jpg are output as a single JPEG file pic1.jpg, so that the thumbnail JPEG image can be effectively output or displayed by decoding the thumbnail JPEG image thu1_jpg without sub-sampling an original image whenever the thumbnail JPEG image is necessary.

In detail, the JPEG signal processing unit 430 includes a scanning unit 431, a DCT signal processing unit 432, a quantization unit 433, a Huffman coding unit 434, and a file combining unit 435. The scanning unit 431 scans the image for main JPEG pic1_main and the image for thumbnail JPEG pic1_thu on a predetermined size (for example, 8*8) block basis. The DCT signal processing unit 432 performs DCT signal processing on the scanned data. The quantization unit 433 quantizes the DCT signal processed data. The Huffman coding unit 434 performs Huffman coding on the quantized data. The file combining unit 435 outputs the main JPEG image main1_jpg and the thumbnail JPEG image thu1_jpg based on the Huffman coded data, inserts the thumbnail JPEG image thu1_jpg into the header area of the main JPEG image main1_jpg, and outputs the main JPEG image main1_jpg and the thumbnail JPEG image thu1_jpg as a single JPEG file pic1.jpg.

The JPEG signal processing unit 430 transfers the output single JPEG file pic1.jpg to the central processing unit 500, and the central processing unit 500 causes the output single JPEG file pic1.jpg to be stored on the memory card 700. Accordingly, the thumbnail JPEG image thu1_jpg is inserted into the header area of the main JPEG image main1_jpg, so that the single JPEG file pic1.jpg, which is output as a single file, is stored on the memory card 700. In this case, it is preferred that the memory card 700 be implemented using non-volatile memory so that the stored single JPEG file pic1.jpg is not damaged.

As shown in FIG. 4, in the memory card 700, a plurality of JPEG files pic1.jpg, pic2.jpg and pic3.jpg, each of which is output as a single file with the main JPEG image main1_jpg inserted into the header area of the main JPEG image main1_jpg, can be stored in different memory addresses 701 to 703, respectively. A description of the data packet structure is made below. The header area 701_header of the main JPEG image main1_jpg includes header data on the size of the main JPEG main1_jpg, and on Discrete Cosine Transform (DCT) signal processing, quantization and Huffman coding methods that are applied to JPEG encoding, and the thumbnail JPEG image thu1_jpg. In contrast, the JPEG image area 701_main of the main JPEG image main1_jpg includes main JPEG image data.

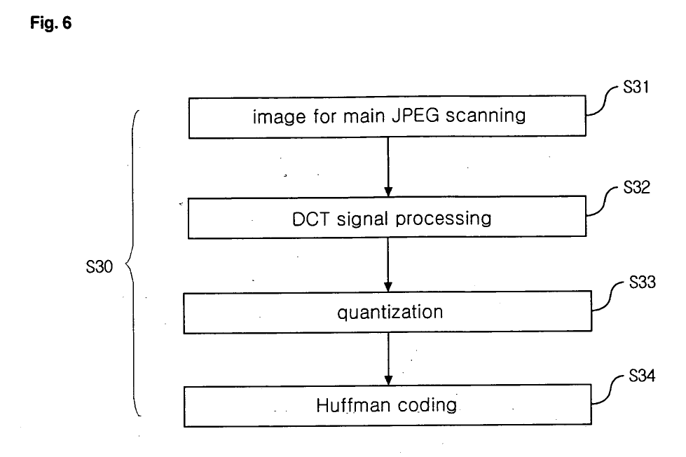

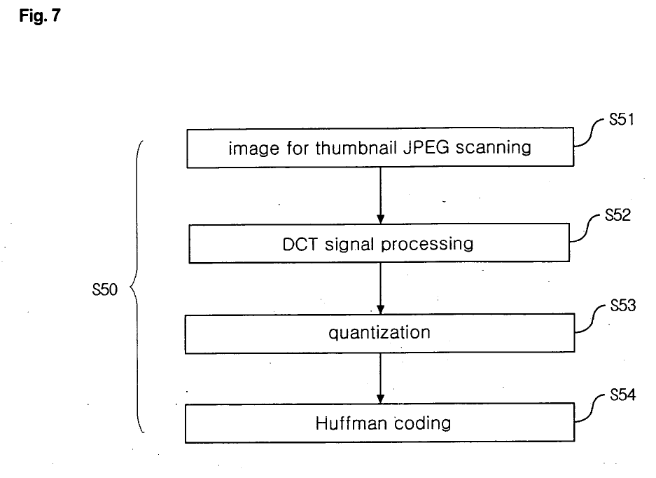

With reference to FIGS. 5 to 7, a method of generating the thumbnail JPEG image thu1_jpg according to the present invention is described below. FIG. 5 is a flowchart illustrating the method of generating the thumbnail JPEG image according to an embodiment of the present invention, FIG. 6 is a detailed flowchart illustrating the step of outputting the main JPEG image of FIG. 5, and FIG. 7 is a detailed flowchart illustrating the step of outputting the thumbnail JPEG image of FIG. 5.

At step S10, the preview scaler 421 scales an image input through the interface 410 to the screen size of the display device 600, such as an LCD, and outputs a display image pic1_pre, the main scaler 422 scales the image input through the interface 410 to a predetermined size and outputs an image for main JPEG pic1_main, and the thumbnail scaler 423 scales the image input through the interface 410 to a size smaller than that of the image for main JPEG pic1_main and outputs an image for thumbnail JPEG pic1_thu.

In this case, the preview scaler 421, the main scaler 422 and the thumbnail scaler 423 can horizontally and vertically interpolate the input image, so that scaling to a previously set size can be simultaneously performed.

At step S20, the preview scaler 421 outputs the display image pic1_pre and transfers it to the memory control unit 450, and the thumbnail scaler 423 outputs the image for thumbnail JPEG pic1_thu and transfers it to the memory control unit 450. The memory control unit 450 transfers the display image pic1_pre and the image for thumbnail JPEG pic1_thu to the first frame memory 441, and the display image pic1_pre and the image for thumbnail JPEG pic1_thu are stored in the first memory 441.

At step S30, the main scaler 422 outputs image for main JPEG pic1_main and transfers it to the JPEG signal processing unit 430, and the JPEG signal processing unit 430 performs JPEG encoding on the image for main JPEG pic1_main, and outputs a main JPEG image main_jpg.

In detail, the step S30 of outputting the main JPEG image main_jpg, as shown in FIG. 6, includes the step S31 of scanning the main JPEG image main_jpg on a predetermined size (for example, a size of 8*8) block basis, the step S32 of the DCT signal processing unit 432 performing DCT processing on the scanned data, the step S33 of the quantization unit 433 quantizing the DCT signal processed data, and the step S34 of the Huffman coding unit 434 performing Huffman coding on the quantized data. The file combining unit 435 outputs the main JPEG image main1_jpg based on the Huffman coded data.

At step 40, the JPEG signal processing unit 430 transfers the output main JPEG image main1_jpg to the memory control unit 450, and the memory control unit 450 transfers the main JPEG image main1_jpg to the second frame memory 442, and the main JPEG image main1_jpg is stored in the second frame memory 442.

At step S50, the image for thumbnail JPEG pic1_thu that has been stored in the first frame memory 441 is transferred to the JPEG signal processing unit 430 under the control of the memory control unit 450, and the JPEG signal processing unit 430 encodes the image for thumbnail JPEG pic1_thu, and outputs a thumbnail JPEG image thu1_jpg.

In detail, the step S50 of outputting the thumbnail JPEG image thu1_jpg includes the step S51 of the scanning unit 431 scanning the image for thumbnail JPEG pic1_thu on a predetermined size (for example, a size of 8*8) block basis, the step S52 of the DCT signal processing unit 432 performing DCT signal processing on the scanned data, the step S53 of the quantization unit 433 quantizing the DCT signal processed data, and the step S54 of the Huffman coding unit 435 performing Huffman coding on the quantized data. The file combining unit 435 outputs the thumbnail JPEG image thu1_jpg based on the Huffman coded data.

At step S60, the JPEG signal processing unit 430 transfers the output thumbnail JPEG image thu1_jpg to the memory control unit 450, the memory control unit 450 transfers the thumbnail JPEG image thu1_jpg to the second frame memory 442, and the thumbnail JPEG image thu1_jpg is stored in the second memory 442.

At step 70, the JPEG signal processing unit 430 receives the main JPEG image main1_jpg and the thumbnail JPEG image thu1_jpg, which are stored in the second frame memory 442, under the control of the memory control unit 450, and the file combining unit 435 inserts the thumbnail JPEG image thu1_jpg into the header area of the main JPEG image main1_jpg, and outputs the thumbnail JPEG image thu1_jpg and the main JPEG image main1_jpg as a single JPEG file pic1.jpg. In this case, the header area of the main JPEG main1_jpg includes data on the size of the main JPEG main1_jpg, and on Discrete Cosine Transform (DCT) signal processing, quantization and Huffman coding methods that are applied to JPEG encoding.

At step 80, the JPEG signal processing unit 430 transfers the output single JPEG file pic1.jpg to the central processing unit 500, the central processing unit 500 transfers the single JPEG file pic1.jpg to the memory card 700, and the single JPEG file pic1.jpg is stored on the memory card 700.

Although the embodiments of the present invention have been described with reference to accompanying drawings, those skilled in the art can appreciate that the present invention may be implemented in some other concrete forms without departing from the scope and spirit of the present invention. Accordingly, since the above-described embodiment is provided to complete the disclosure of the present invention, to describe the present invention in detail to the extent that the technical spirit of the present invention may be easily implemented by those skilled in the art, and to fully notify them of the scope of the present invention, the embodiments are illustrative, but not restrictive in all aspects. The present invention is defined only by the appended claims.

As described above, in accordance with the present invention, the device and method for generating a thumbnail JPEG image and the medium for storing the thumbnail JPEG image insert the thumbnail JPEG image into the main JPEG image, and output the thumbnail JPEG image and the main JPEG image as a single file, so that the thumbnail JPEG image can be effectively output or displayed by decoding the thumbnail JPEG image thu1_jpg without sub-sampling an original image whenever the thumbnail JPEG image is necessary.

What is claimed is:

1. A device for generating a thumbnail Joint Picture Experts Group (JPEG) image, comprising:
a scaler for scaling an input image to a predetermined size and outputting an image for main JPEG, and scaling the input image to a size smaller than the image for main JPEG and outputting an image for thumbnail JPEG;
a first frame memory for storing the image for thumbnail JPEG;
a JPEG signal processing unit for performing JPEG encoding on the image for main JPEG and the image for thumbnail JPEG, and outputting a main JPEG image and a thumbnail JPEG image;
a second frame memory for storing the main JPEG image and the thumbnail JPEG image; and
a memory control unit for transferring the image for thumbnail JPEG to the first frame memory, and transferring the main JPEG image and the thumbnail JPEG image to the second frame memory;
wherein the JPEG signal processing unit receives the main JPEG image and the thumbnail JPEG image stored in the second frame memory, and outputs the main JPEG image and the thumbnail JPEG image as a single JPEG file.

2. The device as set forth in claim 1, wherein the JPEG signal processing unit inserts the thumbnail JPEG image into a header area of the main JPEG image, and outputs the main JPEG image and the thumbnail JPEG image as a single JPEG file.

3. The device as set forth in claim 2, wherein the JPEG signal processing unit comprises a scanning unit for scanning the image for main JPEG and the image for thumbnail JPEG on a predetermined size block basis;
a Discrete Cosine Transform (DCT) signal processing unit for performing DCT signal processing on the scanned data;
a quantization unit for quantizing the DCT signal processed data;
a Huffman coding unit for performing Huffman coding on the quantized data; and
a file combining unit for outputting the main JPEG image and the thumbnail JPEG image based on the Huffman coded data, inserting the thumbnail JPEG image into a header area of the main JPEG image, and outputting the main JPEG image and the thumbnail JPEG image as a single JPEG file.

4. The device as set forth in claim 1, further comprising a memory card for storing the output single JPEG file.

5. A method of generating a thumbnail JPEG image, comprising the steps of:
scaling an input image to a predetermined size and outputting an image for main JPEG, and scaling the input image to a size smaller than the image for main JPEG and outputting an image for thumbnail JPEG;
transferring the image for thumbnail JPEG to first frame memory, and storing the image for thumbnail JPEG in the first frame memory;
outputting a main JPEG image by performing JPEG encoding on the image for main JPEG;
transferring the main JPEG image to second frame memory, and storing the main JPEG image in the second frame memory;
receiving the image for thumbnail JPEG stored in the first frame memory, performing JPEG encoding on the image for thumbnail JPEG, and outputting a thumbnail JPEG image;
transferring the thumbnail JPEG image to the second frame memory, and storing the thumbnail JPEG image in the second frame memory; and
outputting the main JPEG image and the thumbnail JPEG image stored in the second frame memory as a single JPEG file.

6. The method as set forth in claim 5, wherein, in the step of outputting the main JPEG image and the thumbnail JPEG image, the thumbnail JPEG image is inserted into a header area of the main JPEG image, and the main JPEG image and the thumbnail JPEG image are outputted as a single JPEG file.

7. The method as set forth in claim 6, wherein the step of outputting the main JPEG image comprises the steps of:
scanning the image for main JPEG on a predetermined size block basis;
performing DCT signal processing on the scanned data;
quantizing the DCT signal processed data; and
performing Huffman coding on the quantized data.

8. The method as set forth in claim 6, wherein the step of outputting the thumbnail JPEG image comprises the steps of:
scanning the image for thumbnail JPEG on a predetermined size block basis;
performing DCT signal processing on the scanned data;
quantizing the DCT signal processed data; and
performing Huffman coding on the quantized data.

9. The method as set forth in claim 6, further comprising the step of storing the output single JPEG file on a memory card.

10. A medium for storing a thumbnail JPEG image, the medium storing a main JPEG image and a thumbnail JPEG image as a single JPEG file.

11. The medium as set forth in claim 10, wherein the thumbnail JPEG image is inserted into a header area of the main JPEG image, and the main JPEG image and the thumb JPEG image are stored therein as a single JPEG file.
